(19) United States
(12) Patent Application Publication
(10) Pub. No.: US 2008/0138773 A1
(43) Pub. Date: Jun. 12, 2008

(54) System and process for determining the optimal device layout and configuration within a gaming environment

(76) Inventor: Kenneth Lathrop, Berkeley, CA (US)

Correspondence Address: DERGOSITS & NOAH LLP, FOUR EMBARCADERO CENTER, SUITE 1450, SAN FRANCISCO, CA, 94111, US

(21) Appl. No.: 11/634,548

(22) Filed: Dec. 6, 2006

(51) Int. Cl. G09B 25/00

(52) U.S. Cl. 434/72

(57) ABSTRACT

A system and process for determining the optimal device layout and configuration within a gaming environment using a computer implemented environment module configured to generate spatial representations of the gaming environment and the configuration of the gaming device agents within the gaming environment using environment data and device agent data, a computer implemented player agent module configured to characterize gaming players within the gaming environment using player agent data, and a computer implemented optimization module for applying optimization criteria to the environment module and the player agent module to determine the optimal gaming device spatial orientations and gaming configurations.

### FIELD OF THE INVENTION

The present invention relates generally to the field of games of chance in a gaming environment. More specifically, the present invention relates to a system and process for determining the optimal gaming device layout and configuration in a gaming environment. The present invention uses a computer simulation to simulate the gaming environment and model the gaming environment to optimize the operator's objectives.

### BACKGROUND OF THE INVENTION

The modern casino style gaming venue is a highly complex and dynamic environment. Gaming operators can choose to populate their gaming “floor” with a wide variety of gaming devices, each with a number of different options. The gaming devices include, but are not limited to mechanical and electronic slot machines, slots, poker, bingo, keno, and blackjack. Gaming devices also include standard table games such as blackjack, craps, roulette, baccarat, pai gow, and pai gow poker. Further adding to the complexity of the offerings available to the gaming operator, each of these devices can be offered in various denominations, various minimum and maximum wagers, various hold percentages, and hit frequencies. Moreover, as in the case of electronic slot and video gaming devices, the operator can choose from hundreds, if not thousands, of different titles and brands of games.

Further adding to the complexity of the gaming environment is the dynamic flow of different types of gaming patrons. For example, the number and composition of gaming patrons changes, often drastically, at different times of the day and night, different days of the week, different times of the year, as well as during special events, conventions, or marketing promotions. Each of these different compositions of patrons have varying gaming preferences and conditions such as game denomination preference, bankroll limitations, time availabilities for a gaming session, varying comfort zones in a densely populated or sparsely populated environment, and varying interests in a specific type of game.

The popularity of specific gaming machines with patrons is dependent on the likelihood (or perceived likelihood) of winning money at the machine and the intrinsic entertainment value of the machine relative to other available gaming options. Where the available gaming options include a number of competing machines and the expectation of winning each machine is roughly the same (or perceived to be the same), patrons are most likely to be attracted to the most entertaining and exciting of the machines. Accordingly, shrewd operators consequently strive to employ the most entertaining and exciting machines available because such machines attract frequent play and hence increase profitability to the operator.

Accordingly, given the incredibly large number of combinations of gaming devices and options with those devices, it becomes very difficult for the operator to determine and provide the optimal mix of devices for a given number and composition of gaming patrons. Additionally, maintaining and managing the location of gaming devices has also proved to be difficult for the operator. Traditionally, casinos typically contain a large number of gaming machines located in diverse locations within the building to attract various groups of patrons. The machines, for example, may be positioned in several rooms spread over several floors of the building. When changes are made to casino layouts and configurations, it is often difficult for an operator to know how effective those changes have been in increasing revenue.

Therefore, it would be highly desirable to a casino operator to have available a convenient and user-friendly system to determine the optimal mix and placement of gaming devices for a specific type and number of patrons for a specified time period.

### SUMMARY OF THE INVENTION

The present invention is directed to a tool for the gaming operator to determine the optimal layout and configuration of gaming devices for the type and number of patrons during a specified time period. The present invention uses a computer simulation to simulate the gaming environment by introducing a population of player “agents” that reflect the number, composition, desires, and behaviors of the venue's patrons for a given time period. The present invention provides a model that the gaming operator can use to experiment with the different product mixes and layouts.

The present invention further provides the gaming operator the ability to seek out a minimum or maximum objective while changing a variable or variables within a specified range during successive model runs. Using optimization engines that incorporate optimization algorithms, the present invention guides the search for the desired objective. As an example, suppose the gaming operator wants to find a mix of slot machine denominations and layout that will generate the maximum win for a given week. It is well known in the gaming industry that given the different traffic and patron compositions, while one mix of gaming devices might be optimal for a Tuesday morning, the same mix of gaming devices will most likely not be the optimal mix for a Saturday evening. By using the present invention, the gaming operator can use the simulation and optimization tools to determine the optimal mix over the entire week.

The present invention further provides the gaming operator with the ability to understand the impact of contemplated changes to the gaming floor. For example, the current conditions of the gaming environment can be entered into the simulation and optimization tool to generate a set of results. The operator can then enter the contemplated changes into the simulation and optimization tool to generate a second set of results. The two outcomes can then be compared to determine if the proposed changes produce preferable results. This procedure can be repeated as many times as necessary until the desired results are achieved.

The present invention is also directed to a system for determining the optimal device layout and configuration within a gaming environment comprising, at least one computer comprising a processor and at least one storage device for storing data, a computer implemented environment module configured to generate spatial representations of the gaming environment and the configuration of the gaming device agents within the gaming environment using environment data and device agent data, a computer implemented player agent module configured to characterize gaming players within the gaming environment using player agent data, and a computer implemented optimization module for applying optimization criteria to the environment module and the player agent module to determine the optimal gaming device spatial orientations and gaming configurations.

The present invention is further directed to a computer readable medium containing instruction sets for a computer system comprising, a computer implemented environment module configured to generate spatial representations of the gaming environment and the configuration of the gaming device agents within the gaming environment using environment data and device agent data, a computer implemented player agent module configured to characterize gaming players within the gaming environment using player agent data, and a computer implemented optimization module for applying optimization criteria to the environment module and the player agent module to determine the optimal gaming device spatial orientations and gaming configurations.

The present invention is also directed to a process of determining the optimal gaming device layout and configuration within a gaming environment comprising, collecting in at least one database gaming environment data and gaming environment device agent data, generating a spatial representation of the gaming environment and the configuration of the gaming device agents within the gaming environment, collecting in at least one database, player agent data within the gaming environment, selecting optimization criteria, and applying the optimization criteria to the gaming environment data, gaming device agent data, and the player agent data to determine the optimal gaming device spatial orientations and gaming configurations.

The present invention is yet further directed to a process for optimizing a gaming environment layout and configuration comprising, creating a model using player agent characteristics within the gaming environment, spatial orientations of gaming device agents within the gaming environment, and gaming configurations of gaming device agents within the gaming environment, applying a player agent population to the model resulting in a first outcome, applying the player agent population to a revised model created by varying the spatial orientations and the gaming configurations of the gaming device agents within the gaming environment, resulting in a second outcome, repeating the step of applying the player agent population to a revised model created by varying the spatial orientations and the gaming configurations of the gaming device agents within the gaming environment, resulting in a second outcome, multiple times to result in multiple outcomes, and evaluating multiple outcomes to determine the optimal spatial orientation and gaming configuration of gaming device agents within the gaming environment.

### BRIEF DESCRIPTION OF THE DRAWINGS

FIG. 1 illustrates a block diagram of an embodiment of the present invention illustrating a method by which the operator uses environment data to create a gaming environment.

FIG. 2 illustrates a block diagram of an embodiment of the present invention illustrating a method by which the operator generates a gaming device agent population.

FIG. 3 illustrates a block diagram of an embodiment of the present invention illustrating a method by which the operator uses typical patron data to create a simulated player agent.

FIG. 4 illustrates a block diagram of an embodiment of the present invention illustrating a method by which the operator gathers data on casino patron demographics.

FIG. 5 illustrates a block diagram of an embodiment of the present invention illustrating a method by which the operator assigns typical player agent preferences.

FIG. 6 illustrates a block diagram of an embodiment of the present invention illustrating a method by which the operator assigns typical player agent behavior preferences with regards to a particular gaming device.

FIG. 7 illustrates a block diagram of an embodiment of the present invention by which the operator optimizes the model according to a desired objective.

FIG. 8 illustrates a block diagram of an embodiment of the present invention that schematically shows the control system for the present invention.

FIG. 9 illustrates a display screen of an embodiment of the present invention that graphically illustrates the gaming environment.

FIG. 10 illustrates a block diagram of an embodiment of the present invention that schematically shows the behavior of a player agent.

FIG. 11 illustrates a display screen of an embodiment of the present invention that graphically illustrates a computer simulation of a gaming environment.

### DETAILED DESCRIPTION OF THE DRAWINGS

The following is a detailed description of the presently preferred embodiments of the present system and process for determining the optimal layout configuration of gaming machines in a gaming environment invention. However, the present invention is in no way intended to be limited to the embodiments discussed below or shown in the drawings. Rather, the description and the drawings are merely illustrative of the presently preferred embodiments of the invention.

The object of a conventional casino operator is to maximize the casino's profitability. However, as previously discussed, given the incredibly large number of variables and combinations associated with the casino environment, it is very difficult for the operator to determine and provide the optimal mix of devices for a given number and composition of gaming patrons at a specific time. For example, the casino operator does not have control over the patron population and composition at any specific time the casino is in operation. Nor does the casino operator have any control over the specific preferences of patrons entering a casino such as gaming device denomination preferences, game type preferences, area density preferences, and device neighbor activity preferences. Similarly, the casino operator also does not have control over the various attributes of patrons entering a casino, such as time availability, vision distance, financial resources, minimum scores for rating preferences, determining score threshold, determining maximum number of moves, moving player agent to an entrance, and choosing an entrance to enter into a gaming environment.

However, the casino operator does have control over the gaming environment and the gaming devices (device agents) themselves. For example, with regards to the gaming environment, the casino operator knows that some locations in a casino generate better performance than other locations. Device agents located near areas where patrons tend to congregate, such as food or drink bars, may experience heavier traffic than machines located in more obscure places within the casino. Using this information, a casino can better make decisions relating to device agent density and placement. Information gathered by the casino may also be used to determine the effect of other factors in a casino on gaming machine performance. For instance, it may be determined that persons standing in line near a narrow restaurant door entrance may tend to use proximately located device agents more so than individuals who do not have to wait in line to enter an open area food location. In this way, the casino operator can define the physical space, pathways, perimeters, exits, location of restaurants, bars, stores and other items to attract patrons.

The casino operator also has control over the specific types of gaming device agents placed in the casino environment. For example, the casino operator can choose to place a certain device agent device in a specific location based on the device's attributes such as, identification, denomination, denomination range, game type, holding percentage, hit frequency, and average wager. As a further example, the casino operator can also choose to place a certain device agent based on the device's profit, utilization, credits in, credits out, credits played, credits won, jackpots and other prizes won, titles of games played, theme type (e.g., animals, people, brand, photos, cartoons, etc.), game type (e.g., mechanical slots, video slots, video poker, video keno, video blackjack, video bingo, table games, etc.), machines played, denominations of games played (e.g., nickel, dime, quarter, half-dollar, dollar, etc.), frequency of play of each denomination, number of games played, duration of play, specific times of play (e.g., time of day, week, month, and year), time between games, contemporaneous events (e.g., fight night, concerts, tradeshows, etc.), days since first installation of titles on the casino floor, days since first installation of machines on the casino floor, locations of titles on the casino floor, locations of machines on the casino floor, maximum number of credits that can be wagered, average number of credits wagered, median number of credits wagered, average number of lines played, median number of lines played, type of bonus feature (e.g., free spins, second screen bonus, both, neither, prize, etc.), overall payback percentage, base game payback percentage, bonus game payback percentage, hit frequency, hit frequency of bonus round, volatility index, predominant glass color, cabinet finish, door finish (e.g., chrome, gold, or paint), sound (style of music), top award size, consistency of credits played (hand to hand), top box style, and type of casino (e.g., independent or chain).

As a result, the information on each gaming device agent when used in conjunction with the information about the casino environment can provide the casino operator with greater control in its ability to maximize the casino's profits. The casino operator can use these data parameters to build a model that identifies the optimal performance at any given point in time. The model can further be used with various gaming device agent configurations and environment layouts to calculate optimal performance of the casino.

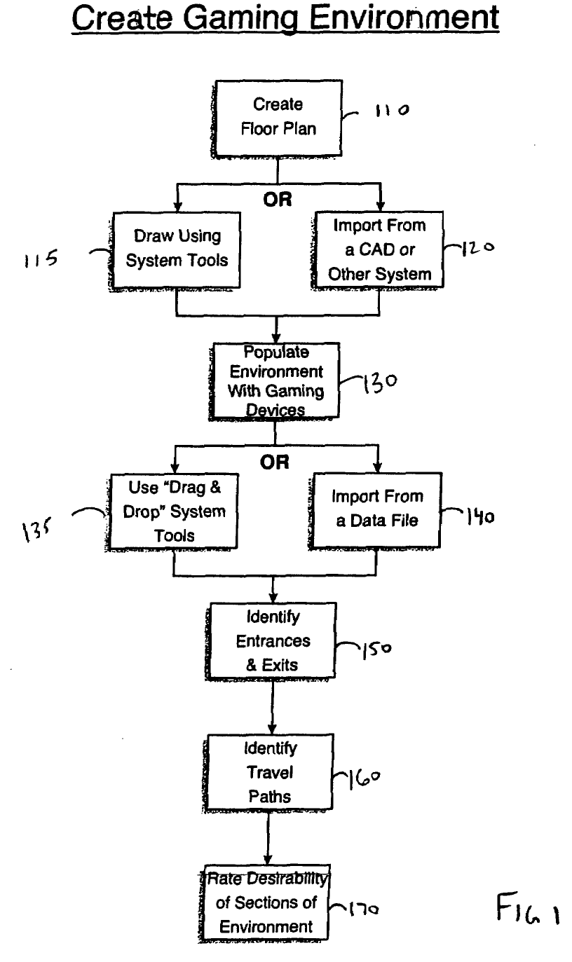

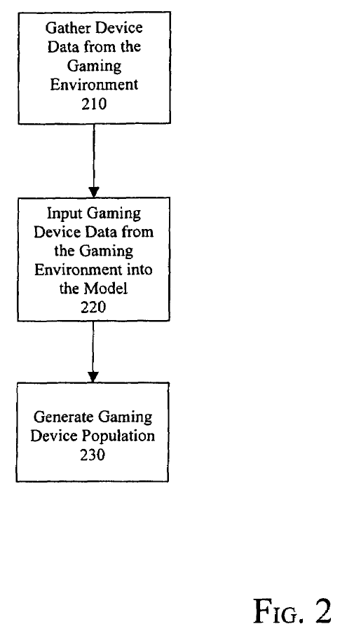

The first step in creating a model requires the operator to create a gaming environment. FIG. 1 illustrates a block diagram of an embodiment of the present invention where the operator uses environment data to create a gaming environment. The first step 110 in creating a gaming environment requires the operator to create a floor plan. The next step 115 requires the operator to draw the floor plan using system tools. Alternatively, the next step can be step 120 where the operator draws the floor plan using tools imported from computer aided design (CAD) programs, or any other wide range of computer-based tools that are used to assist architects and design professionals in their design activities. In the next step 130, the operator populates the gaming environment with specific gaming device agents after gaming device agent data is gathered by the operator (see FIG. 2 below). The operator may populate the gaming environment by taking the step 135 of “dragging and dropping” specific gaming device agents using system tools. Alternatively, the operator may populate the gaming environment by taking the step 140 of importing data on the gaming environment from a data file. In the next step 150, the operator identifies entrances and exits. In the next step 160, the operator identifies travel paths throughout the casino. In the final step 170, the operator rates the desirability of sections of the environment, for example, as previously mentioned, the casino operator knows that some locations in a casino generate better performance than other locations—device agents located near areas where patrons tend to congregate, such as food or drink bars, may experience heavier traffic than machines located in more obscure places within the casino.

FIG. 2 illustrates a block diagram of an embodiment of the present invention. In the first step 210, the operator gathers device agent data such as the handle win per unit for each gaming device for a selected period of time, headcount activity, or any of the other device agent characteristics and attributes described above. In the next step 220, data gathered from the gaming device agents is entered into the model or alternatively, the operator may import gaming device agent data from a data file stored in a database. In the next step 230, the operator generates a gaming device agent population. Once the gaming device agent population is generated, the operator using the gaming device agent population to populate the gaming environment, as previously discussed in step 130 of FIG. 1.

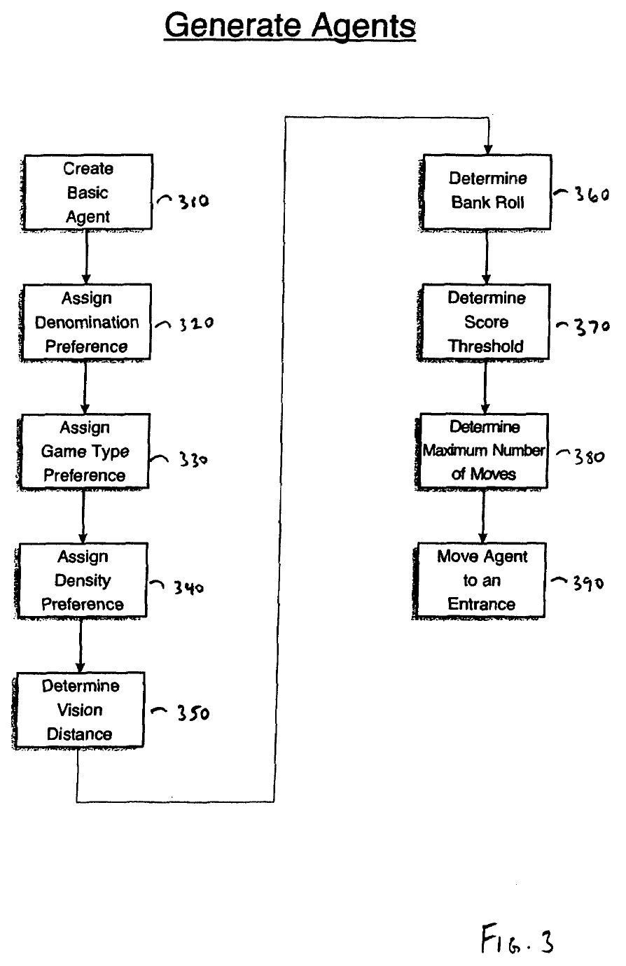

The next step in creating a model requires the operator to create a player agent population. FIG. 3 illustrates a block diagram of an embodiment of the present invention where the operator uses typical patron data to create a simulated player agent. Ideally, this data will reflect the gaming patrons in the real world gaming venue. By using this data, the operator can use the model to generate probability distributions that will create a set of preferences for each agent so that the simulated agent population will have a similar set of preferences as the gaming patron population. In the first step 310 of an embodiment of the present invention, a basic player agent is created. In the next step 320, a denomination preference is assigned to the player agent. In the next step 330, a game type preference is assigned to the player agent. In the following step 340, a density preference is assigned to the player agent. In the next step 350, a vision distance is assigned to the player agent. In the following step 360, a bankroll or budget is assigned to the player agent. In the next step 370, a score threshold is assigned to the player agent. In the next step 380, a maximum number of moves are assigned to the player agent. In the last step 390, the player agent is moved to an entrance. In this way, a very large number of player agents can be created to reflect the population and distribution of a gaming patron population for a specific point in time, be it Tuesday morning or Friday night.

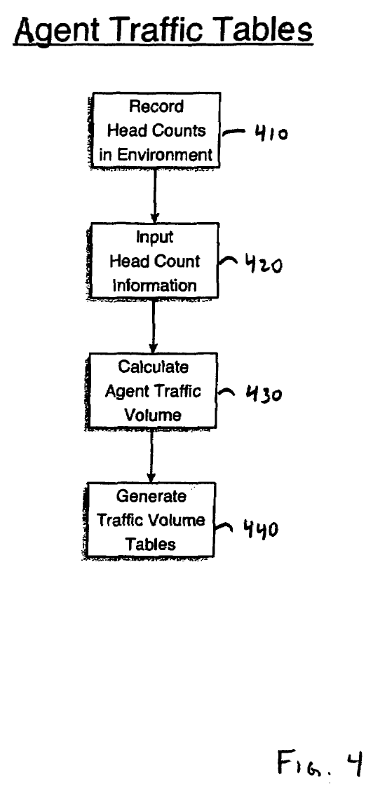

FIG. 4 illustrates a block diagram of an embodiment of the present invention where the operator gathers data on casino patron demographics. This data is used by the operator to generate a player agent population by the methods disclosed above. In the first step 410, the operator records the number of actual patrons in a gaming environment for a specific time. In the next step 420, the operator inputs the patron head count into a formula or algorithm to determine patron density. In the following step 430, the operator uses the formula or algorithm to calculate player agent traffic volume for a specific time. In the last step 440, these calculations are repeated to generate player agent traffic volume tables that can be applied to simulated player agents to mimic actual patron traffic patterns. The player agent traffic tables can then be used to create an accurate representation of the population of gaming patrons for a specific point in time, be it Tuesday morning or Friday night. This player agent population is introduced at the entrance of the casino and behaves according to assigned behavior patterns.

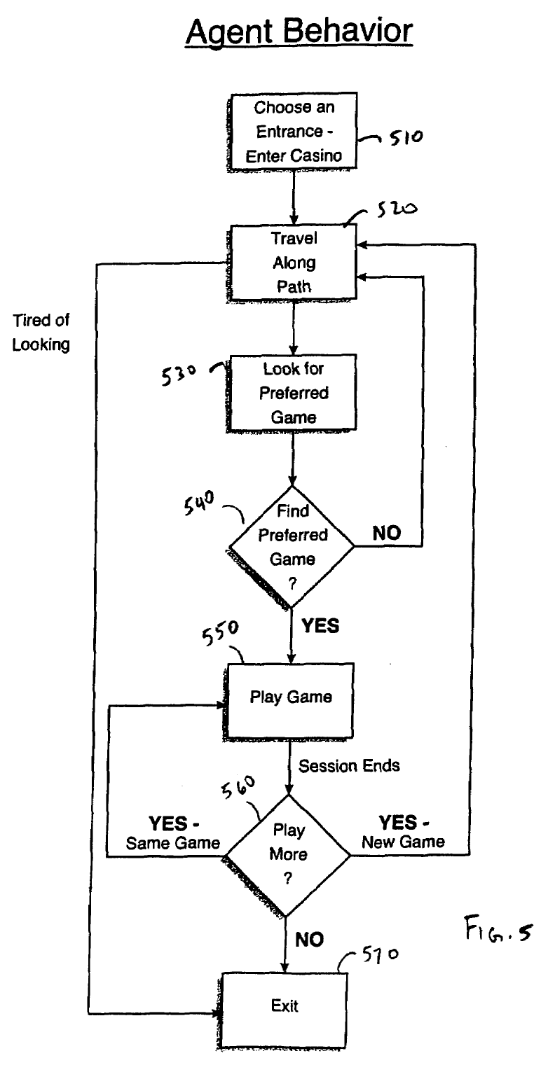

FIG. 5 illustrates a block diagram of an embodiment of the present invention where the operator assigns typical casino patron preferences to create a simulated player agent that mimics actual patron behaviors. These preferences can be applied to each player agent within a population to create a simulated casino gaming environment. In the first step 510, the player agent is assigned to a specific entrance to the casino. In the next step 520, the player agent travels along the designated walkways within the casino environment. While traveling, the player agent performs the next step 530 of looking for a preferred game. If the player agent finds a preferred game, it performs the next step 550 of playing the game. Alternatively, if the player agent does not find a preferred game continues steps 520 and 530 of traveling along the path and looking for a preferred game. If the player agent is tired of looking, it can perform the next step 570 of exiting the casino. However, once the player agent plays the game and after the session ends, the player agents takes the next step 560 of deciding to play more. If the player agent chooses to play the same game, step 550 is repeated. If the player agent chooses to play a new game, step 520 is repeated. Alternatively, if the player decides to exit the casino step 570 is executed. In this way, typical casino patron behavior is assigned to player agents in the model to generate a simulated casino environment.

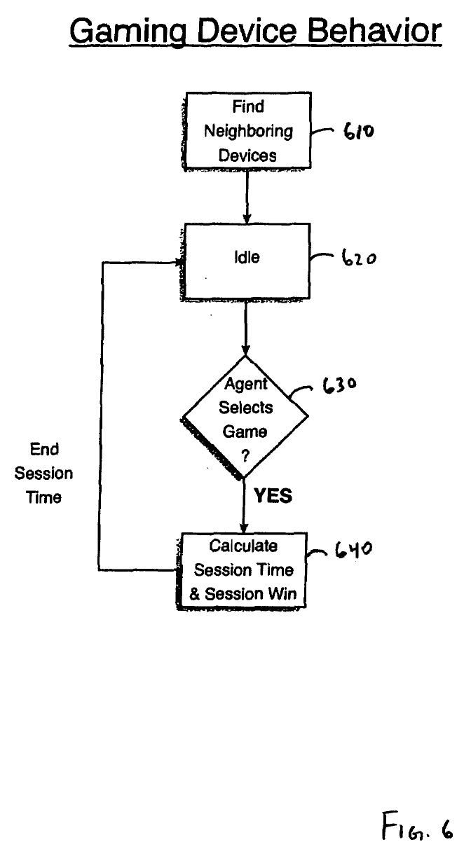

FIG. 6 illustrates a block diagram of an embodiment of the present invention where the operator assigns typical player agent behavior preferences with regards to a particular gaming device. In the first step 610, the player agent finds a gaming agent according to its preference. In the next step 620, the player agent determines if the gaming agent is idle. If the gaming agent is idle, the player agent performs the next step 630 of selecting the game. Once the game is played and after the player agent leaves, the device agent performs the next step 640 of calculating and tabulating information about the game played, such as the session time and session win results.

Using the aforementioned data, the model generates probability distributions to regulate player agent flow and behavior. The operator can either accept these recommendations or override them and enter probability distribution data of their own choosing. Once the appropriate data is assigned to the environment, player agent and device agent, the model is run for a selected time period and the results are compared to real world data. If the simulation differs significantly from the real world data, the operator is able to make changes in the probability distributions that will change the player agent's behavior. Once the operator is satisfied that the model functions similarly to the real system, he can then elect to optimize the model.

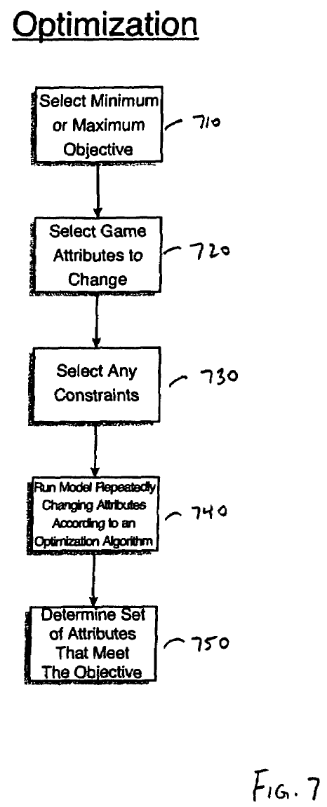

FIG. 7 illustrates a block diagram of an embodiment of the present invention where the operator optimizes the model according to a desired objective. In the first step 710 the operator selects a minimum or maximum objective. For example, the operator can select the objective of maximizing slot machine revenue. In the next step 720, the operator selects game device agent attributes he wants to change. In the above referenced example, an attribute that can be selected is machine denomination for a selected group of machines that could be in the range of nickel, quarter, or dollar machines. In the next step 730, the operator selects any constraints he wishes to apply to the model. In the following step 740, the model would run repeatedly, changing attributes according to an optimization algorithm. In the final step 750, the model would compare the varying results and determine the set of attributes that meet the objectives identified the first step 710. Essentially, this final set of attributes, meets the aforementioned objective in the example, the highest slot machine revenue, is considered optimal.

The methods described in FIGS. 1 through FIG. 7 can be repeated to search for optimal solutions to many problems and to make further refinements in the model to produce increasingly accurate results. By modifying the variables that are within the control of the casino operator, the present invention can be used to determine the optimal set of conditions for a specific objective or a set of objectives.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “computer network” and “online” may be used interchangeably and do not imply a particular network embodiment or topography. In general, any type of network (e.g., LAN, WAN, or Internet) may be used to implement the online or computer networked implementation of the present invention.

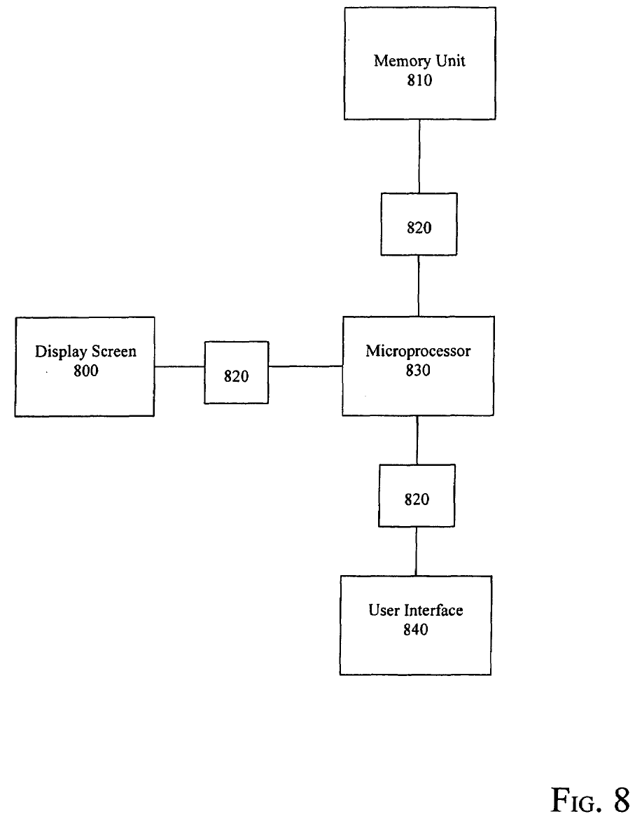

FIG. 8 is an illustrative diagram of an embodiment of the present invention, where aspects of the present invention are implemented on a typical computer. In the preferred embodiment, microprocessor 830, memory unit or units 810, user interface 840, and display screen 800 communicate and interact with one another using computer-executable instruction 820, which are generally and commonly known to those familiar with the art. Display screen 800 presents the user with a tool to view the results of the computer simulated optimization model. Display screen 800 may incorporate touch-screen technology, with a fully or partially integrated user interface 840. In the preferred embodiment, screen 800 is directly connected to microprocessor 830. Screen 800 is also connected to memory unit 810.

Memory unit 810 is connected to microprocessor 830 and stores data that has been processed by microprocessor 830. Data stored in memory unit 810 directly correlates to data obtained on the casino gaming environment, device agents, player agents, and casino patron preferences, characteristics, and attributes. Although this data can be stored in many different forms, microprocessor 810 must translate this data to visual data for screen 800 in the form of tables, charts, engineering plans, distribution curves, or other graphic components of the casino gaming environment and population.

Microprocessor 830 is further connected to user interface 840. The operator utilizes user interface 840 to enter data obtained on the casino gaming environment, device agents, player agents, and casino patron preferences, characteristics, and attributes, which is then stored in memory unit 810.

In an embodiment, the present invention is comprised of at least three modules, an “environment module,” a “player agent module,” and an “optimization module.” In one embodiment, the environment module, player agent module and optimization module reside on a client computer and can be integrated as part of existing system software programs. Alternatively, any of the three modules can be downloaded from another location, such as, e.g., a server computer, and installed on the client's computer to work with any type of optimization software program, including desktop, web-based, web-enabled or ASP. In another embodiment, the optimization software program applies the environment module and player agent module over a network connection, where either the optimization program or the environment module or the player agent module is server-based.

Microprocessor 830 utilizes the environment module to generate spatial representations of the gaming environment and the configurations of the device agents using environment data and device agent data. In the preferred embodiment, the environment module comprises system drawing tools or tools imported from CAD programs run by microprocessor 830, and tools to generate device agents. Alternatively, the environment module can include any other wide range of computer-based tools that are used to assist architects and design professionals in their design activities. In yet another embodiment, the environment module is capable of generating a model or representation of the gaming venue or a network of gaming venues. The environment module includes timers that control the simulation of the gaming environment. The environment module allows for mapping of the gaming environment in two or three dimensions using Cartesian coordinates. Once the gaming environment is created, the environment data and device agent data is stored in memory unit 810. Microprocessor 830 uses this data to generate tables, charts, graphic models, and also to generate a device agent gaming population, which can be displayed on display screen 800.

Microprocessor 830 utilizes the player agent module to characterize gaming players within the gaming environment using player agent data. In the preferred embodiment, the player agent module includes system software and other tools that are generally known to those familiar with the art. Once player agents are created using microprocessor 830, the player agent data is stored in memory unit 810 and can be displayed on display screen 800 in the form of tables, charts, graphics, and the like.

Microprocessor 830 utilizes optimization module for applying optimization criteria to the environment module and the player agent module to determine the optimal gaming device spatial and gaming configurations. In the preferred embodiment, the optimization module includes system software and other tools that are generally known to those familiar with the art. For example, optimization module can be a single computer program, a collection of computers or even an entire network such as the Internet. Once a maximum or minimum objective is identified, microprocessor 830 utilizes the optimization module, at each time changing a selected attribute or attributes within a specified range. The setting of attributes that produces the stated maximum or minimum objective is displayed on display screen 800 in the form of tables, charts, and/or graphics. This process can be repeated as many times as necessary to test various maximum and minimum criteria.

In the preferred embodiment, data collected for the environment module may be organized into tables, charts, and graphic models. Table 1 below is an exemplary embodiment of data representing the path and walkways in the gaming environment that player agents can use to navigate within the environment. Here the path and walkway of the gaming environment is mapped according to Cartesian coordinates for given points.

TABLE 1
Pseudo Code “PATHS”

| Point Number | X coordinate | Y coordinate |
|---|---|---|
| 0 | 200 | 50 |
| 1 | 200 | 100 |
| 2 | 250 | 150 |
| 3 | 300 | 150 |

This set of data is merely exemplary and represents a specific subset of all possible data which may be collected and which may be used to implement the data analysis techniques of the present invention. Once data concerning the gaming environment is tabulated and organized, the environment module applies this data to generate a simulated gaming environment for the operator.

The environment module also applies the data collected on the various attributes of the device agents within the environment. The device agent's attributes determine its appeal to the player agent. These attributes are assigned to the device agent when it is created and do not change during its existence. The attributes are entered into the environment module or are imported from a data file. In the preferred embodiment, the device agent's attributes comprise of the device identification, location, denomination or denomination range, game type, grouping identification, hold percentage, hit frequency, and average wager. However, this list of attributes in no way limits the total number of attributes that can be assigned to any particular device agent.

In the preferred embodiment, the device agents continue to gather data regarding their immediate environment. For example, the device agent is aware of its current state (active or idle), its location, its neighboring device agents, and the state of its neighboring device agents. The device agent further calculates a session's duration and win/(loss) based upon the player agent's buy in and the device agent's specific attributes. The attributes of the device agent, as well as the other data collected by the device agent during the simulation, are entered into the environment module to generate a simulated gaming environment.

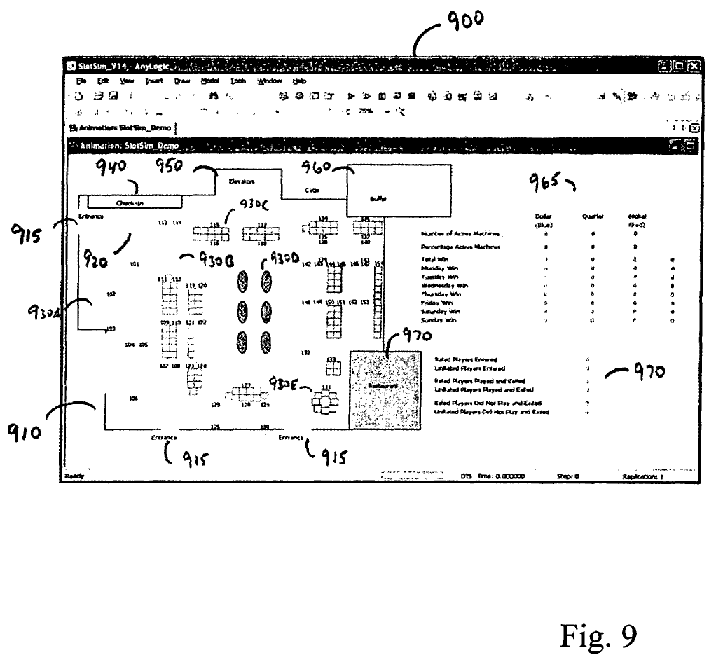

FIG. 9 is an exemplary display screen 900 graphically illustrating a computer simulation of a gaming environment 910, generated by the environment module. Environment 910 accurately resembles an actual or proposed gaming environment. Environment 910 has designated entrances 915 and pathways 920 that lead to an assortment of various gaming device agents 930A, 930B, 930C, 930D, and 930E which represent various electronic machines of different denominations such as, slot machines, slots, poker, bingo, keno, blackjack, and standard table games such as blackjack, craps, roulette, baccarat, pai gow, and pai gow poker. Different games can also be color-coded based on minimum wager amounts. Pathways 920 also lead to the check-in counter 940 where the player can register and check in. Pathways 920 also lead to the elevators 950, the buffet 960, and the restaurant 970. To the right of environment 910 is a chart 965 reflecting the number of device agents and the percentage of active device agents further classified by dollar, quarter, and nickel denominations. In an alternative embodiment, chart 965 can reflect various other data of the device agents such as the device's profit, utilization, credits in, credits out, credits played, credits won, jackpots and other prizes won, titles of games played, theme type, or any other data collected about the device agent.

Casino operators also want to maximize their relationships with players to obtain greater profitability-through-customer loyalty. In this regard, operators are increasingly implementing customer relationship management (CRM) software and services to pool essential player tracking data from all casino and hotel departments into a global storage system. Such data may, for example, player preferences, attributes, characteristics, gender, age, where a player lives, games played, and coins played per game and is used to identify high-value (big-spending) customers. Chart 970 also to the right of environment 910 keeps track of certain high-value and “rated” player agents that simulate the number of actual rated players that enter the casino based on the data collected by the operator.

In the preferred embodiment, the player agent is a software component that represents a patron in a casino. In the preferred embodiment, the player agent module includes system tools run by microprocessor 830 to generate player agents. Alternatively, the player agent module can include any other wide range of computer-based tools that are used by graphic artists, statisticians, or other gaming professionals.

The player agent has several preferences that shape the agents behavior. These preferences are assigned to the player agent when it is created and do not change during the life of the player agent. Table 2 below is an exemplary embodiment of data within tables or databases used to generate the number and entry point into the environment for player agents. For example, as indicated below, a player agent can be introduced to the gaming environment at various entrances and at predefined intervals. One skilled in the art would understand that the following table summarizes such predefined time intervals associated with certain events.

TABLE 2
Pseudo Code “TRAFFIC VOLUME TABLE”

| TIME | Agent Entrance Distribution |
|---|---|
| 0< system | Create an New Agent on average 5 per hour |
| Time <4 | Place in entrance 1 20% if the time, entrance 2 30% of the |
| | time and entrance 3 50% of the time |
| 4< system | Create an New Agent on average 7 per hour |
| Time <8 | Place in entrance 1 30% if the time, entrance 2 30% of the |
| | time and entrance 3 40% of the time |

As noted above, this set of data is merely exemplary and represents a specific subset of all possible data which may be collected and which may be used to implement the data analysis techniques of the present invention. Once data concerning the gaming environment is tabulated and organized, the environment module applies this data to generate a simulated gaming environment for the operator.

In the preferred embodiment, the player agent's preferences are organized into tables. The player agent's preferences are determined by distributions tied to the system time and/or other system conditions. Table 3 below is an exemplary embodiment of data within tables or databases used to generate a player agent's preferences for a gaming agent. For example, as indicated below, a player agent can be introduced to the gaming environment at predefined intervals and would select a particular gaming agent based on a predefined preference distribution. One skilled in the art would understand that the following table summarizes such predefined time intervals associated with certain events. As noted above, this set of data is merely exemplary and represents a specific subset of all possible data which may be collected and which may be used to implement the data analysis techniques of the present invention.

TABLE 3
Pseudo Code “DEVICE DISTRIBUTION TABLE”

| TIME | Device Preference Distribution |
|---|---|
| 0< agentStartTime<24 | If random <.30 Game Device Preference = 3 |
| | line slot |
| | Else if random <.70 Game Device Preference = |
| | 5 line slot |
| | Else Game Device Preference = video poker |
| 24< agentStartTime<48 | If random <.40 Game Device Preference = |
| | 3 line slot |
| | Else if random <.60 Game Device Preference = |
| | 5 line slot |
| | Else Game Device Preference = video poker |

Table 4 below is an exemplary embodiment of data within tables or databases used to generate a player agent's preference for a certain denomination of gaming agent. For example, as indicated below, a player agent can be introduced to the gaming environment at predefined intervals and would select a particular gaming agent based on a predefined denomination preference distribution. One skilled in the art would understand that the following table summarizes such predefined time intervals associated with certain events. As noted above, this set of data is merely exemplary and represents a specific subset of all possible data which may be collected and which may be used to implement the data analysis techniques of the present invention.

TABLE 4
Pseudo Code “DENOMINATION DISTRIBUTION TABLE”

| TIME | Denomination Preference Distribution |
|---|---|
| 0< agentStartTime<24 | If random <.25 Game Denom Preference = |
| | nickel |
| | Else if random <.70 Game Denom |
| | Preference = quarter |
| | Else Game Denom Preference = dollar |
| 24< agentStartTime<48 | If random <.40 Game Denom Preference = |
| | nickel |
| | Else if random <.60 Game Denom |
| | Preference = quarter |
| | Else Game Denom Preference = dollar |

Table 5 below is an exemplary embodiment of data within tables or databases used to generate a player agent's preference for the density of gaming agents. For example, as indicated below, a 3-line slot device agent with a nickel denomination is placed in the gaming environment at a certain distribution density. Similarly, a video poker device agent with a quarter denomination is also placed in the gaming environment at a certain distribution density. One skilled in the art would understand that the following table summarizes such predefined device agents at certain densities. As noted above, this set of data is merely exemplary and represents a specific subset of all possible data which may be collected and which may be used to implement the data analysis techniques of the present invention.

TABLE 5
Pseudo Code “DENSITY PREFERANCE TABLE”

| Game Type & | |
|---|---|
| Denomination | Density Preference Distribution |
| 3 line slot/nickel | 0< probability Distribution (0.5) <1 |
| Video Poker/quarter | 0< probability Distribution (0.33) <1 |

Table 6 below is an exemplary embodiment of data within tables or databases used to generate a player agent's neighbor activity preference. For example, as indicated below, a 5-line slot device agent with a dollar denomination is placed in the gaming environment at a certain neighbor activity preference and given pre-assigned preferences. Similarly, a 3-line slot device agent with a quarter denomination is also placed in the gaming environment at a certain neighbor activity preference and given pre-assigned preferences. One skilled in the art would understand that the following table summarizes such predefined device agents at certain densities. As noted above, this set of data is merely exemplary and represents a specific subset of all possible data which may be collected and which may be used to implement the data analysis techniques of the present invention.

TABLE 6
Pseudo Code “NEIGHBOR ACTIVITY PREFERANCE TABLE”

| Game Type & | |
|---|---|
| Denomination | Neighbor Activity Preference Distribution |
| 5 line slot/dollar | If random <.1 Neighbor Active Preference = 2 |
| | Else if random <.50 Neighbor Active Preference = 1 |
| | Else Neighbor Active Preference = 0 |
| 3 line slot/quarter | If random <.15 Neighbor Active Preference = 2 |
| | Else if random <.60 Neighbor Active Preference = 1 |
| | Else Neighbor Active Preference = 0 |

The player agent also has several attributes that also shape the player agent's behavior. These attributes are assigned to each individual player agent when it is created and in contrast with player agent preferences, do change during the life of the player agent. In the preferred embodiment, the player agent's attributes are organized into tables. The player agent's attributes are attributes are determined by distributions tied to the system time and/or other system conditions.

Table 7 below is an exemplary embodiment of data within a table or database used to generate the preferred amount of time a player agent plays in the gaming environment. For example, as indicated below, a player agent can play in the gaming environment for predefined time intervals based on a predefined preference distribution. One skilled in the art would understand that the following table summarizes such predefined time intervals associated with certain events. As noted above, this set of data is merely exemplary and represents a specific subset of all possible data which may be collected and which may be used to implement the data analysis techniques of the present invention.

TABLE 7
Pseudo Code “PLAY TIME DISTRIBUTION TABLE”

| Time | Play Time Preference Distribution |
|---|---|
| 0< agentStartTime<24 | probability Distribution (2) |
| 24< agentStartTime<48 | probability Distribution (2.5) |

Table 8 below is an exemplary embodiment of data within tables or databases used to generate a player agent's bankroll for a certain device agent. For example, as indicated below, a 3-line slot device agent with a nickel denomination is assigned a certain preference distribution. Similarly, a video poker device agent with a quarter denomination is also assigned a certain preference distribution. One skilled in the art would understand that the following table summarizes such predefined preference distributions associated with certain device agents. As noted above, this set of data is merely exemplary and represents a specific subset of all possible data which may be collected and which may be used to implement the data analysis techniques of the present invention.

TABLE 8
Pseudo Code “BANKROLL TABLE”

| Game Type & | |
|---|---|
| Denomination | Bankroll Distribution |
| 3 line slot/nickel | probability Distribution (50) |
| Video Poker/quarter | probability Distribution (75) |

Table 9 below is an exemplary embodiment of data within tables or databases used to generate a player agent's minimum score preferences. The player agent uses the minimum score when evaluating a gaming device agent. The player agent rates a device's attributes and assigns it a score, creating a total score for each device agent. The player agent's minimum score represents a threshold for the player agent to accept a device agent that might not meet all of it's preferences, but does meet enough to be deemed acceptable for play. For example, as indicated below, a player agent created in a certain time period with certain game type and denomination preferences will receive different minimum scores, indicating how particular an agent is when finding an acceptable game to play. One skilled in the art would understand that the following table summarizes such predefined preference distributions associated with certain device agents. As noted above, this set of data is merely exemplary and represents a specific subset of all possible data which may be collected and which may be used to implement the data analysis techniques of the present invention.

TABLE 9
Pseudo Code “MINIMUM SCORE TABLE”

| | Game Type & | |
|---|---|---|
| Time | Denominations | Minimum Score Distribution |
| 0< agentStartTime<24 | 5 line slot/ | minScore = 18 |
| | dollar | |
| 0< agentStartTime<24 | 3 line slot/ | minScore = 15 |
| | quarter | |

Table 10 below is an exemplary embodiment of data within tables or databases used to generate a player agent's vision distance. For example, as indicated below, a player agent is introduced into a gaming environment at a predefined timed distribution. The player agent's game preference distribution is assigned a probability distribution based upon the ability of the player agent to see a certain gaming device. One skilled in the art would understand that the following table summarizes such predefined preference distributions associated with certain device agents. It follows that device agents close to walkways and the entrance of the gaming environment would have a higher preference distribution than devices tucked away in the middle of the gaming casino. As noted above, this set of data is merely exemplary and represents a specific subset of all possible data which may be collected and which may be used to implement the data analysis techniques of the present invention.

TABLE 10
Pseudo Code “VISION DISTANCE”

| Time | Game Preference Distribution |
|---|---|
| 0< agentStartTime<24 | probability Distribution (200) |
| 24< agentStartTime<48 | probability Distribution (300) |

Table 11 below is an exemplary embodiment of data within tables or databases used to generate a player agent's buy in for a specific device agent. For example, as indicated below, a 3-line slot device agent with a nickel denomination is assigned a certain preference distribution based upon the product of the player agent's bankroll and the probability distribution. Similarly, a video poker device agent with a quarter denomination is also assigned a certain preference distribution based upon the product of the player agent's bankroll and the probability distribution. One skilled in the art would understand that the following table summarizes such predefined preference distributions associated with certain device agents. As noted above, this set of data is merely exemplary and represents a specific subset of all possible data which may be collected and which may be used to implement the data analysis techniques of the present invention.

TABLE 11
Pseudo Code “BUY IN TABLE”

| Game Type & | |
|---|---|
| Denomination | Agent's Bank Roll × Probability Distribution |
| 3 line slot/nickel | 200 * probability Distribution (0.25) |
| Video Poker/quarter | 200 * probability Distribution (0.75) |

In the preferred embodiment, the player agent is aware of its environment. The player agent knows its location in the environment, the device agent it is using when playing, the percentage of active players in the portion of the environment they are in, the number and types of device agents that are within their vision distance, and whether the gaming devices directly next to the device it is using is occupied. Once data governing the preferences and attributes of the player agent is collected in databases and organized into tables as described above, the player agent's behavior is determined by the following manner. First the player agent is created and introduced to the,gaming environment according to the interval determined by the TRAFFIC VOLUME Table (described in detail above). Next, the player agent is placed at an entrance to gaming environment. Next, the player agent's game type preference is determined. Next, the player agent's denomination preference is determined. Next, the player agent's density preference is determined. Next, the player agent's neighbor Activity preference is determined. Next, the amount of time available for playing a gaming agent is determined. Next, the player agent's vision distance is determined. Next, the player agent's bankroll is determined. Next, the player agent's buy in is determined. Next the player agent's minimum score is determined.

Then, the player agent moves along the travel paths described in the PATHS Table (described above). At various point along the path the player agent looks for a gaming agent to play. The player agent records all devices within its vision distance that are Idle. The player agent also scores each device agent based on the player agent's preferences. If the device agent's score exceeds the player agent's minimum score, that device agent becomes a candidate for play. Once all device agents have been evaluated a device agent is selected as a candidate. The player agent sends a message to the idle selected device agent and the device agent changes from “idle” to “active” . Next, the player agent's bankroll is reduced by the buy in amount. The device agent determines the player agent's session time and session win/loss ratio. At the end of the session time for the particular game, the player agent checks the environment to see if the density in the area and the number of active neighbors are less that its preferences, and if the player agent's bankroll is greater that its buy in. If these conditions are met, the player agent starts another session with the same device agent or seeks another device agent. If the density or number of neighbors exceeds the player agent's preferences, the player agent leaves the device agent and continues on the path outlined in the Paths Table. The player agent begins a new search for a device agent to play. If the player agent's buy in exceeds its bankroll, the player agent exits the system.

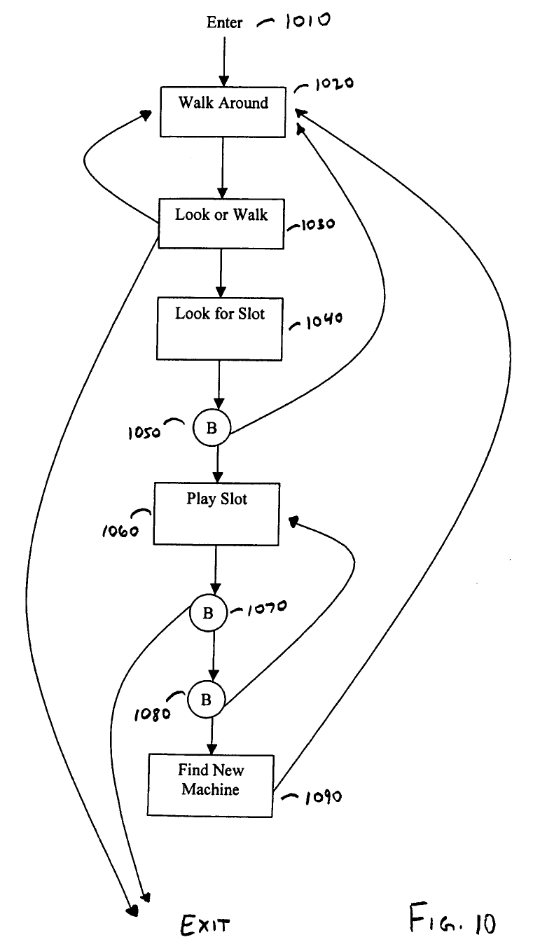

FIG. 10 illustrates a block diagram of an embodiment of the present invention where the player agent is introduced into the gaming environment. In the first step 1010 the player agent enters the gaming environment. In the next step 1020, the player agent walks around the gaming environment. In the next step 1030, the player agent either continues to walk, looks for a device agent, or if he is tired of looking exits the gaming environment. If the player agent chooses to walk, then the previous step 1020 is repeated. If the player chooses to look for a device agent, he performs the next step 1040 of finding a specific device agent that suits his preferences and attributes. Next 1050 the player agent determines if its bankroll is greater than the buy in amount. If the player agent's buy in is greater, in the next step 1060, the player agent plays the device agent. Once the device agent is played, in the next step 1070, the player agent's bankroll is reduced by the buy in amount. At this step, the player agent can choose to exit the gaming environment. Alternatively, if the player wishes to continue play, in the next step 1080, the player agent can determine whether its bankroll is greater than the buy in amount. If the player agent's bankroll is greater, the player agent repeats step 1060 and plays the device agent. If the player agent's bankroll is greater than the buy in amount but it still wants to continue play, but on a different device, the player agent repeats step 1020 and begins walking around the gaming environment. These steps are repeated until the player agent exits the gaming environment. These steps are further repeated for every player agent introduced into the gaming environment.

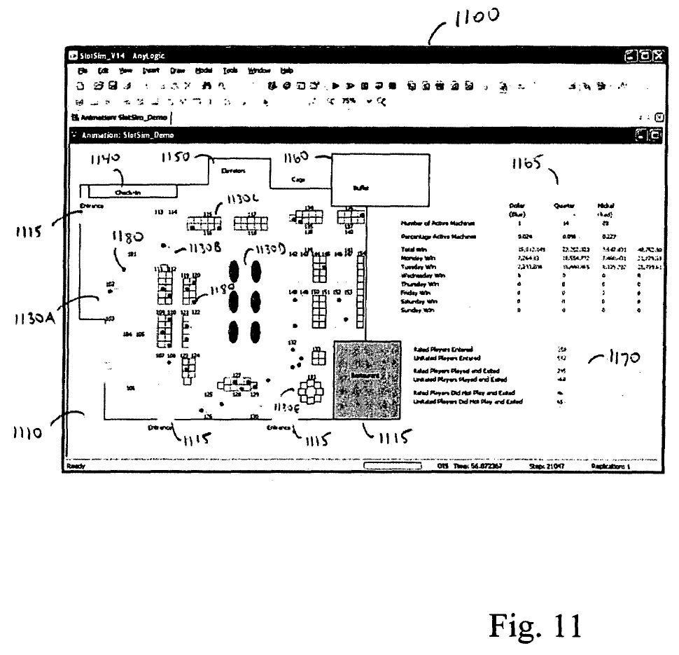

FIG. 11 is an exemplary display screen 1100 graphically illustrating a computer simulation of a gaming environment 1110, generated by the environment module, and incorporating numerous player agents 1180 using the player agent module. As before environment 1110 accurately resembles an actual or proposed gaming environment. Environment 1110 has designated entrances 1115 and pathways 1120 that lead to an assortment of various gaming device agents 1130A, 1130B, 1130C, 1130D, and 1130E, which represent various electronic machines of different denominations such as, slot machines, slots, poker, bingo, keno, blackjack, and standard table games such as blackjack, craps, roulette, baccarat, pai gow, and pai gow poker. Different games can also be color-coded based on minimum wager amounts. Pathways 1120 also lead to the check-in counter 1140 where the player can register and check in. Pathways 1120 also lead to the elevators 1150, the buffet 1160, and the restaurant 1170. To the right of environment 1110 is a chart 1165 reflecting the number of device agents and the percentage of active device agents further classified by dollar, quarter, and nickel denominations. In an alternative embodiment, chart 1165 can reflect various other data of the device agents such as the device's profit, utilization, credits in, credits out, credits played, credits won, jackpots and other prizes won, titles of games played, theme type, or any other data collected about the device agent. Therefore, once the environment module generates a spatial representation of the gaming environment 1110 based upon the environment data and the device agent data, player agents 1180 introduced into gaming environment 1110 behave according to their preferences and attributes as previously discussed. Consequently, the optimization module applies optimization criteria to the environment module and the player agent module to determine the optimal device agents and device agent spatial configurations.

In the preferred embodiment, as previously mentioned, the optimization module includes system software and other tools that are generally known to those familiar with the art. For example, optimization module can be a single computer program, a collection of computers or even an entire network such as the Internet. As a further example, the optimization module may employ algorithms and mathematical formulae associated linear programming, integer programming, quadratic programming, nonlinear programming, convex programming, semi-definite programming, second order cone programming, hyperbolic programming, stochastic programming, robust programming, dynamic programming, combinatorial optimization, infinite-dimensional optimization, constraint satisfaction studies, or any other tools generally known to those familiar with the art.

As a further example, the optimization module may use any number of optimization software packages known to those familiar with the art such as, the AIMMS modeling language, the AMPL modeling language, the ANALYZE linear programming model analysis, the ASA-adaptive simulated annealing, COMPACT design optimization, CONSOL-OPTCAD engineering system design, DATAFORM—model management system, DFNLP—nonlinear data fitting, DOC (design optimization control program), EASY FIT parameter estimation in dynamic systems, Excel and Quattro Pro Solvers spreadsheet-based linear, integer and nonlinear programming, EZMOD modeling environment for decision support systems, FSQP nonlinear and min/max constrained optimization, GAUSS matrix programming language, GOM (global optimization for mathematics), LBFGS unconstrained minimization, and NLPJOB multi-criteria optimization, OPTDES design optimization tool.

While the present invention has been described in terms of a preferred embodiment above, those skilled in the art will readily appreciate that numerous modifications, substitutions and additions may be made to the disclosed embodiment without departing from the spirit and scope of the present invention. It is intended that all such modifications, substitutions and additions fall within the scope of the present invention that is best defined by the claims below.

What is claimed is:

1. A system for determining the optimal device layout and configuration within a gaming environment comprising:
(a) at least one computer comprising a processor and at least one storage device for storing data;
(b) a computer implemented environment module configured to generate spatial representations of the gaming environment and the configuration of the gaming device agents within the gaming environment using environment data and device agent data;
(c) a computer implemented player agent module configured to characterize gaming players within the gaming environment using player agent data; and
(d) a computer implemented optimization module for applying optimization criteria to the environment module and the player agent module to determine the optimal gaming device spatial and gaming configurations.

2. The system of claim 1, wherein environment data comprises specific attributes of the gaming device agents selected from the group consisting of device identification, location, denomination, denomination range, game type, grouping identification number, holding percentage, hit frequency, and average wager.

3. The system of claim 1, wherein player agent data comprises specific preferences of player agents selected from the group consisting of gaming device denomination preferences, area density preferences, and device neighbor activity preferences.

4. The system of claim 1, wherein player agent data comprises specific to attributes of player agents selected from the group consisting of time availability, vision distance, financial resources, and minimum scores for rating preferences.

5. A computer readable medium containing instruction sets for a computer system comprising:
(a) a computer implemented environment module configured to generate spatial representations of the gaming environment and the configuration of the gaming device agents within the gaming environment using environment data and device agent data;
(b) a computer implemented player agent module configured to characterize gaming players within the gaming environment using player agent data; and
(c) a computer implemented optimization module for applying optimization criteria to the environment module and the player agent module to determine the optimal gaming device spatial orientations and gaming configurations.

6. The computer readable medium of claim 5, wherein environment data comprises specific attributes of the gaming device agents selected from the group consisting of device identification, location, denomination, denomination range, game type, grouping identification number, holding percentage, hit frequency, and average wager.

7. The computer readable medium of claim 5, wherein player agent data comprises specific preferences of player agents selected from the group consisting of gaming device denomination preferences, area density preferences, and device neighbor activity preferences.

8. The computer readable medium of claim 5, wherein player agent data comprises specific to attributes of player agents selected from the group consisting of time availability, vision distance, financial resources, and minimum scores for rating preferences.

9. A process of determining the optimal gaming device layout and configuration within a gaming environment comprising:
(a) collecting in at least one database gaming environment data and gaming environment device agent data;
(b) generating a spatial representation of the gaming environment and the configuration of the gaming device agents within the gaming environment;
(c) collecting in at least one database, player agent data within the gaming environment;
(d) selecting optimization criteria; and
(e) applying the optimization criteria to the gaming environment data, gaming device agent data, and the player agent data to determine the optimal gaming device spatial orientations and gaming configurations.

10. The process of claim 9, wherein the step of collecting the environment data comprises specific attributes of the gaming device agents selected from the group consisting of device identification, location, denomination, denomination range, game type, grouping identification number, holding percentage, hit frequency, and average wager.

11. The process of claim 9, wherein the step of collecting the player agent data comprises specific preferences of player agents selected from the group consisting of gaming device denomination preferences, game type preferences, area density preferences, and device neighbor activity preferences.

12. The process of claim 11, wherein the step of collecting player agent data preferences comprises values assigned to gaming environment walkways, search for a preferred device agent, and decision to play and continue to play a preferred device agent.

13. The process of claim 9, wherein the step of collecting the player agent data comprises specific attributes of player agents selected from the group consisting of time availability, vision distance, financial resources, minimum scores for rating preferences, determining score threshold, determining maximum number of moves, moving player agent to an entrance, and choosing an entrance to enter into a gaming environment.

14. The process of claim 9, wherein the step of generating spatial representations of the gaming environment comprises using the gaming environment data to create a floor plan of the gaming environment, populate the gaming environment with device agents, identify entrances and exits in the gaming environment, identify travel paths in the gaming environment, and rate the desirability of sections of the gaming environment.

15. The process of claim 14 wherein the gaming environment is created and populated with gaming device agents using system tools or imported system tools.

16. The process of claim 16, wherein the step of collecting player agent data comprises recording the number of player agents in the gaming environment, calculating player agent traffic volume, and generating player agent traffic volume datapoints.

17. A process for optimizing a gaming environment layout and configuration comprising:
(a) creating a model using player agent characteristics within the gaming environment, spatial orientations of gaming device agents within the gaming environment, and gaming configurations of gaming device agents within the gaming environment;
(b) applying a player agent population to the model resulting in a first outcome;
(c) applying the player agent population to a revised model created by varying the spatial orientations and the gaming configurations of the gaming device agents within the gaming environment, resulting in a second outcome;
(d) repeating step (c) multiple times to result in multiple outcomes; and
(e) evaluating multiple outcomes to determine the optimal spatial orientation and gaming configuration of gaming device agents within the gaming environment.

18. The process of claim 17, wherein the step of creating a model by using spatial orientations of gaming device agents comprises applying specific attributes of the gaming device agents selected from the group consisting of device identification, location, denomination, denomination range, game type, grouping identification number, holding percentage, hit frequency, and average wager.

19. The process of claim 17, wherein the step of creating a model by using player agent characteristics comprises collecting player agent data specific preferences selected from the group consisting of gaming device denomination preferences, game type preferences, area density preferences, and device neighbor activity preferences.

20. The process of claim 19, wherein the step of collecting player agent data preferences comprises values assigned to gaming environment walkways, search for a preferred device agent, and decision to play and continue to play a preferred device agent.

21. The process of claim 17, wherein the step of creating a model by using player agent characteristics comprises collecting player agent data specific attributes selected from the group consisting of time availability, vision distance, financial resources, minimum scores for rating preferences, determining score threshold, determining maximum number of moves, moving player agent to an entrance, and choosing an entrance to enter into a gaming environment.

22. The process of claim 17, wherein the step of applying player agent population comprises recording the number of player agents in the gaming environment, calculating player agent traffic volume, and generating player agent traffic volume data.

23. The process of claim 17, wherein the step of creating a model by using spatial orientations of the gaming environment comprises using data to create a floor plan of the gaming environment, populate the gaming environment with gaming device agents, identify entrances and exits in the gaming environment, identify travel paths in the gaming environment, and rate the desirability of sections of the gaming environment.

24. The process of claim 17 wherein the gaming environment is created and populated with gaming device agents using system tools or imported system tools.
